(19) United States
(12) Patent Application Publication
(10) Pub. No.: US 2021/0316797 A1
(43) Pub. Date: Oct. 14, 2021

(54) Personal Transportation Vehicle

(71) Applicant: Kelvin Cannon, Washington, DC (US)

(72) Inventor: Kelvin Cannon, Washington, DC (US)

(21) Appl. No.: 17/222,163

(22) Filed: Apr. 5, 2021

Related U.S. Application Data
(60) Provisional application No. 63/008,865, filed on Apr. 13, 2020.

(51) Int. Cl. B62D 31/00; B60K 1/04; B60K 1/00; B60L 8/00; B60L 50/60; B60Q 1/50; B60J 7/00; B60R 7/04; B60J 1/00; B60J 5/04; B60Q 5/00; B60L 53/16; B60N 2/02; G09F 9/33; G09F 21/04

(52) U.S. Cl. CPC B62D 31/003; G01S 19/13; B60K 1/00; B60L 8/003; B60L 50/60; B60Q 1/503; B60J 7/00; B60R 7/04; B60J 1/00; B60J 5/04; B60Q 5/00; B60L 53/16; B60N 2/02; G09F 9/33; G09F 21/048; B60K 1/04

(57) ABSTRACT

The present invention relates to a personal transportation vehicle that protects riders from weather conditions and contracting or spreading airborne diseases while traveling through crowded city environments. The vehicle is comprised of a pod-like enclosure having a plurality of panels and preferably three wheels, wherein each panel is further comprised of a viewing window. Several features of the personal transportation vehicle may also be controlled by voice command such as, but not limited to, GPS navigation, vehicle direction, vehicle engine, etc. The vehicle is also comprised of at least one interior display and a virtual and/or augmented reality system

### CROSS-REFERENCE TO RELATED APPLICATION

The present application claims priority to, and the benefit of, U.S. Provisional Application No. 63/008,865, which was filed on Apr. 13, 2020 and is incorporated herein by reference in its entirety.

### FIELD OF THE INVENTION

The present invention relates generally to the field of transportation devices. More specifically, the present invention relates to a personal transportation vehicle that protects riders from weather conditions and contracting or spreading airborne diseases while traveling through crowded city environments. The vehicle device is comprised of a pod-like enclosure having a plurality of panels and at least three wheels, wherein each panel is further comprised of a viewing window. Several features of the personal transportation vehicle may also be controlled by voice command such as, but not limited to GPS navigation, vehicle direction, vehicle engine, etc. The vehicle is also comprised of at least one interior display that may display a virtual and/or augmented reality system to a rider. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Various vehicles, such as automobiles, buses, motorcycles and the like, are used by individuals for travelling every day. Said vehicles are normally comprised of a roof and sides that provide a driver shelter from extreme weather conditions while travelling in the vehicle to various destinations. However, larger vehicles such as cars may be undesirable for more crowded environments such as large cities, which have smaller streets, smaller sidewalks, more traffic and may only require small distances to be traveled. As a result, most individuals prefer walking or using smaller vehicles such as bicycles, scooters, motorcycles, etc. to travel relatively short distances and/or to avoid traffic in a crowded city environment. Further, using smaller vehicles allows an individual to avoid the time wasted it takes to park a car/vehicle in a garage and to sit in traffic on busy streets.

However, smaller vehicles such as bicycles, scooters, motorcycles and the like typically do not have any sides or an overhead roof/covering. Therefore, a rider is susceptible to inclement weather in the form of rain, snow, heat, etc., as well as airborne pathogens while riding on the vehicle. Additionally, bicycles, scooters, motorcycles and the like typically require that the rider maintain balance, and therefore may be more difficult to learn to ride than an automobile. As a result, many individuals may not be able to ride a two-wheeled vehicle safely and/or effectively.

Further, during a pandemic or during the spread of other infectious diseases, walking or travelling short distances using smaller vehicles may be unsafe, as bicycles, motorcycles, scooters and the like are typically not enclosed like an automobile. As a result, the rider is oftentimes exposed to potentially infectious airborne pathogens and other harmful pollutants. Not only can a rider become infected with harmful pathogens, germs, bacteria, or the like from passing pedestrians, but the riders themselves can also infect other individuals in the same vicinity. Therefore, the chances of cross contamination are very high due to the fact that motorcycles, bicycles, scooters, and other small vehicles of the like fail to shield and protect riders and pedestrians alike against the transmission of germs, bacteria and other harmful pathogens during their commute.

Therefore, there exists a long felt need in the art for a personal transportation vehicle that enables a rider to travel short distances in crowded city environments. There is also a long felt need in the art for a personal transportation vehicle that is enclosed and as a result shelters the rider from inclement weather conditions. Moreover, there is long felt need in the art for a personal transportation vehicle that also protects the driver and other pedestrians in close proximity thereto from the spread of infectious diseases. Finally, there is a long felt need in the art for a personal transportation vehicle that is relatively inexpensive to manufacture and operate and that is both safe and easy to use.

The subject matter disclosed and claimed herein, in one embodiment thereof, comprises a personal transportation vehicle for travelling in crowded environments while remaining in minimal contact with other pedestrians in the surrounding area. The vehicle is comprised of a pod-like housing having each of a top panel, front panel, back panel, opposing side panels, a front hood assembly, and preferably three wheels. All of the panels of the housing are further comprised of at least one viewing window that allows a driver to view their surroundings while operating the vehicle. In addition, the interior of the housing may be comprised of a padded interior seat, a voice operated engine, a horn to alert other pedestrians, and a virtual reality display system that displays the surrounding in a augmented reality manner.

In this manner, the novel personal transportation vehicle of the present invention accomplishes all of the forgoing objectives, and provides a relatively safe, convenient and cost-effective personal transportation vehicle. Further, the personal transportation vehicle offers a solution for riders to travel outdoors in crowded environments while being protected from extreme weather conditions and from contracting or spreading infectious diseases, germs, bacteria, viruses and the like. The personal transportation vehicle of the present invention is also user friendly, inasmuch as it offers the drivability and protection of a full-size vehicle while offering the maneuverability of a smaller vehicle.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a personal transportation vehicle that allows a rider to travel in a crowded environment while remaining in minimal contact with other pedestrians. The vehicle is comprised of a housing having a top panel, a bottom panel, a front panel, a back panel, two opposing side panels, a front hood assembly, and preferably three wheels arranged in a triangular fashion. All the panels of the body are preferably comprised of at least one viewing window that allow a rider to view outside of the housing. In differing embodiments of the vehicle, the viewing window maybe be comprised of a vinyl window, an acrylic window, a motorized roll-down window, etc. that can attach to each panel via a plurality of fastening means. At least one panel may further be comprised of a foldable door that allows a user to enter into the housing. Further, the roof or other panel of the device may be comprised of a storage rack. Each panel may also be comprised of a plurality of logos or advertisements, and may be comprised of a plurality of LED advertising boards.

As previously stated, the transportation vehicle is preferably comprised of at least three wheels, and said wheels may move simultaneously or independently from one another via at least one axle. The wheels are preferably arranged in a triangular configuration with one lead wheel in front of two rear wheels. Accordingly, the wheels then allow the device to move in any direction. In one embodiment of the device, the steering of the vehicle can also be controlled by voice commands.

The interior of the vehicle is further comprised of a padded, height-adjustable interior seat and a steering assembly. Further, the interior may also be comprised of at least one display, GPS system and/or a virtual reality system that shows the surrounding environment of the vehicle in an augmented reality fashion. Several mechanisms of the vehicle can further be controlled by voice operation, such as an electrical engine, the navigation of the vehicle, radio, horn, etc. The vehicle may also be comprised of a wireless communication module to allow for Wi-Fi/cellular pairing with a smartphone or other smart device which allows a user to control various functions of the vehicle via the mobile application.

The vehicle may also be comprised of at least one rechargeable electric battery that can be charged by a charging port that is positioned along one of the vehicle's panels. Alternatively, the battery and engine can be charged via a plurality of solar panels that are located on the roof panel of the vehicle and that are in electrical communication with the battery. In addition, one embodiment of the vehicle may be controlled autonomously, wherein the vehicle only requires a rider to input their desired destination.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the personal transportation vehicle of present invention in accordance with the disclosed architecture;

FIG. 2 illustrates a side cross-sectional view of one potential embodiment of the personal transportation vehicle of the present invention in accordance with the disclosed architecture, wherein a user is positioned within the interior of the vehicle; and

FIG. 3 illustrates a diagrammatic view of the essential components of one potential embodiment of the personal transportation vehicle of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a personal transportation vehicle that enables a rider to easily travel in crowded city environments, and that is enclosed so as to shelter the rider from inclement weather conditions. Moreover, there is long felt need in the art for a personal transportation vehicle that also protects riders and other pedestrians in close proximity thereto from the spread of infectious diseases, germs, bacteria, viruses, harmful particulates and the like. Finally, there is a long felt need in the art for a personal transportation vehicle that is relatively inexpensive to manufacture and operate and that is both safe and easy to use.

In one preferred embodiment, the personal transportation vehicle of the present invention allows a rider to travel in a crowded environment while maintaining minimal, if any, contact with other pedestrians who may transmit airborne diseases, germs, pathogens, etc. to the rider or who may contract airborne diseases, germs, pathogens, etc. from the rider. As explained in further detail below, the vehicle is preferably comprised of a top panel, bottom panel, front panel, back panel, two opposing side panels, a front hood assembly and preferably three wheels arranged in a generally triangular fashion. Each of the panels of the vehicle (with the exception of the bottom panel) is preferably comprised of at least one viewing window that allows the rider to view outside the vehicle and that allows sunlight into the interior of the vehicle. In differing embodiments of the device, the viewing window maybe be comprised of a vinyl window, an acrylic window, a motorized roll-down window, etc. and can be formed into the panel or attached thereto by one or more fastening means. Additionally, one or both of the opposing side panels may be comprised of a repositionable door that allows the rider to enter or exit the device, and the roof panel may be comprised of a storage rack that allows a user to store and/or transport various items with the vehicle.

The vehicle is also preferably comprised of at least two and preferably three wheels that are connected via at least one axle to the bottom panel, wherein the wheels may move simultaneously or independently from one another. The three wheels are also preferably arranged in a triangular configuration with one lead wheel positioned in front of the two rear wheels. Nonetheless, in an alternate embodiment of the vehicle, two lead wheels may be positioned in front of one rear wheel. Accordingly, the wheels allow the vehicle to move or turn in any direction while a user looks through any number of viewing windows in the panels to navigate the vehicle. In one embodiment, the steering of the vehicle can also be controlled by voice command or the integrated GPS in an automatous manner, or may be physically controlled by a rider via the steering wheel in a conventional manner. Unless otherwise stated herein, all of the various components of the personal transportation vehicle are commercially available as separate parts.

The interior of the vehicle is further comprised of a padded, height-adjustable interior seat, and at least one display for displaying a GPS system and/or a virtual reality system that shows the surrounding environment of the vehicle in an augmented reality fashion. The augmented reality system can further display a visual representation of the route suggested by the GPS overlaying the real-world environment. Further, the system may contain a plurality of games which interact with the real-world environment by creating artificial game elements that interact with the environment.

Several mechanisms of the vehicle can further be controlled by voice operation. These mechanisms include the power status of the electrical engine (e.g. whether the engine is on or off), the vehicle's steering system, horn, the GPS navigation, etc. The vehicle further comprises a wireless communication module to allow for Wi-Fi/cellular pairing with a smartphone or other smart device that also allows a user to control the various functions of the vehicle via a mobile application. The vehicle is further comprised of an electric engine and at least one rechargeable electric battery that can be charged by a charging port positioned along at last one panel of the housing. Additionally or alternatively, the battery and engine can be charged via a plurality of solar panels that are located on the roof or another panel of the housing of the vehicle.

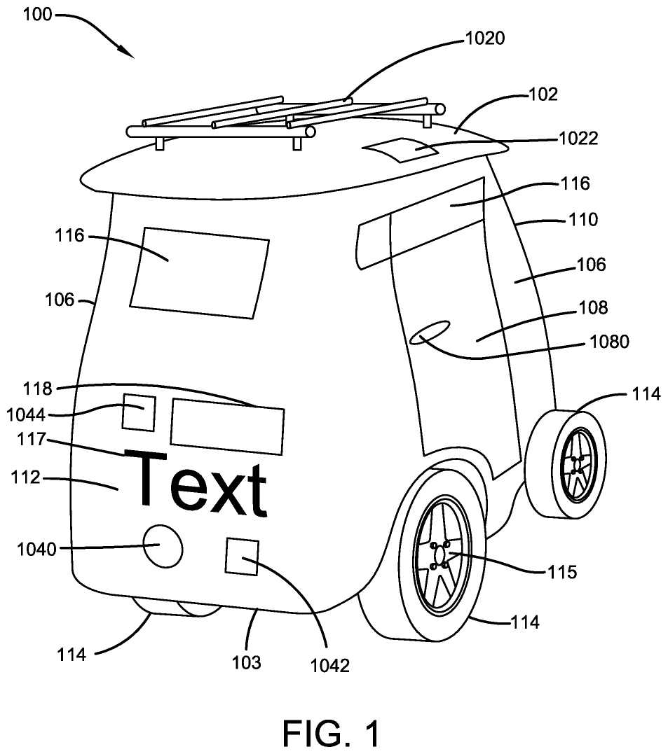

Referring initially to the drawings, FIG. 1 illustrates a perspective view of one potential embodiment of the personal transportation vehicle 100 of present invention in accordance with the disclosed architecture. As shown, the generally-rectangular or pod-like body of the vehicle 100 is comprised of a removable top panel 102 (i.e. a roof) that may be used to support a storage rack 1020 and/or a plurality of solar panels 1022, a bottom panel 103 (i.e., floor), a front panel 104 (i.e. windshield), two opposing side panels 106 wherein at least one of the side panels 106 has a door 108 that attaches to the side panel 106 via a hinge 1080, a back panel 110 and front hood assembly 112.

It is contemplated that any of panels 102, 103, 104, 106, 110, 112 may be comprised of at least one solar panel 1022 and at least one storage rack 1020 in differing embodiments of the vehicle 100. In addition, each of panels 102, 106, 110 may also be removable. Unless otherwise stated herein, each of panels 102, 103, 104, 106, 110, 112 is preferably made from a durable and lightweight material such as, but not limited to, a plastic, fiberglass, aluminum, titanium, etc., and one or more of said panels (or at least a portion thereof) and may be transparent or semi-transparent to enable a rider to look out of the vehicle 100 and/or to let sunlight into the vehicle 100. Further, the exterior surface of each of the panels 102, 104, 106, 110, 112 (i.e., the surface opposite of the interior of the vehicle 100) may feature any number of indica in the form of advertisements, brand/company logos, images, text, etc. that may be printed on the surface of said panels. In one embodiment, the exterior of one or more of panels 104, 106, 110, 112 may be comprised of at least one illuminated LED display board 118 that displays advertisements, brand/company logos, images, text, etc.

In other differing embodiments of the vehicle 100, any panel 102, 104, 106, 110, 112 may be comprised of any number, shape, and arrangement of viewing windows 116 that allow a rider 20 to view the environment around the vehicle 100 while driving and to allow ambient light into the vehicle 10. In such differing embodiments, the windows 116 may be comprised of a plurality of different materials such as, but not limited to, a glass, plexi-glass, acrylic glass, etc. In addition, one embodiment of the device 100 may be comprised of windows 116 in the form of continuous openings instead of a window material or may alternatively be comprised of a vinyl film screen. The vinyl film can further be attached to any panel of panels 102, 104, 106, 110, 112 via a plurality of attachment means such as, but not limited to, a zipper fastening means, a hook and loop fastening means, a snap-button fastening means, an adhesive fastening means, a magnetic fastening means, etc. Further, the windows 116 may be comprised of a traditional motorized vehicle window that rolls up/down, wherein the position of the windows 116 can further be controlled by one or more voice commands.

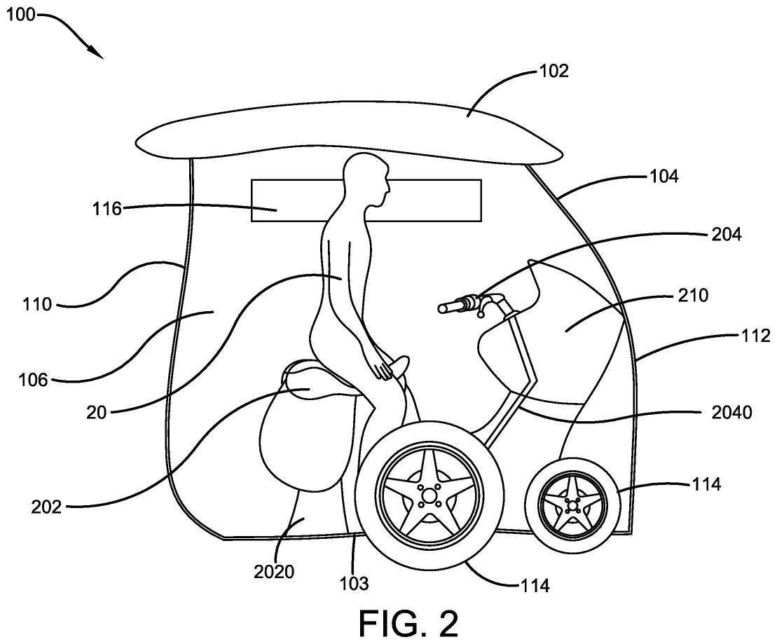

FIG. 2 illustrates a side cross-sectional view of one potential embodiment of the personal transportation vehicle 100 of the present invention in accordance with the disclosed architecture, wherein a user 20 is positioned within the interior of the vehicle 100. In this embodiment, the vehicle 100 is comprised of three wheels 114. The wheels 114 may be fixedly or removably attached to the bottom panel 103 in differing embodiments of the device 100 via at least one axle 115. In the preferred embodiment of the vehicle 100, the three wheels 114 are arranged in a triangular pattern with two wheels 114 positioned behind a central front wheel 114. However, differing embodiments of the vehicle 100 may be comprised of a plurality of differing wheel locations, positions, orientations, sizes and numbers.

Each wheel 114 may be controlled simultaneously or independently from one another via a handlebar assembly 204 which connects to the wheels 114 and/or axles 115 via a steering column 2040. In differing embodiments of the vehicle 100, the handlebar assembly 204 may instead take the form of a wheel, a half wheel, a yoke, etc., and the vehicle 100 may also be controlled using voice commands as opposed to the steering column 2040. The interior of the vehicle 100 is also further comprised of one or more seats 202 that attach to the floor panel 103 via a support column 2020. In differing embodiments, the seat 202 may take the form of a saddle or a padded seat that is height adjustable. The seat 202 may also possess a plurality of different features such as, but not limited to, heating elements, cooling elements, massage elements, reclining elements, etc.

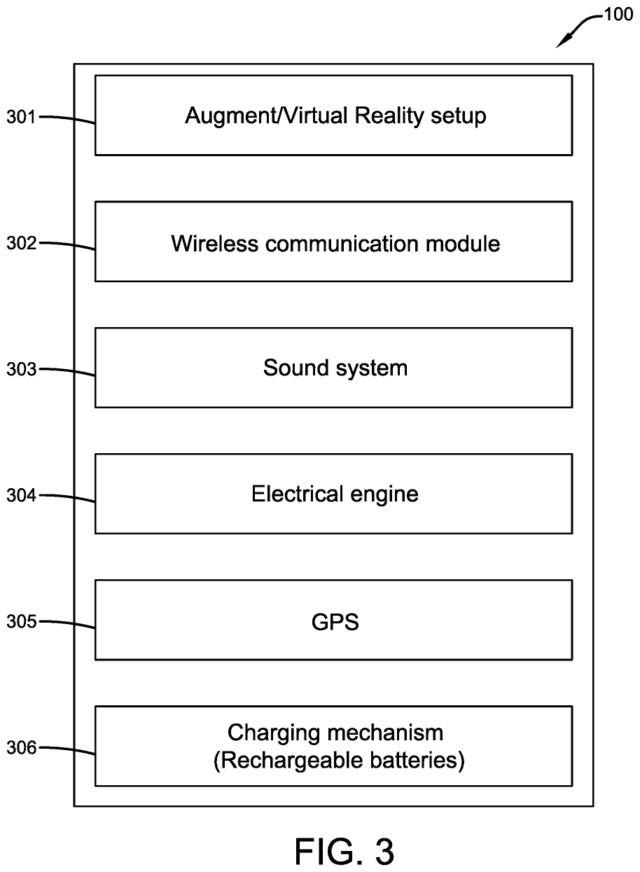

FIG. 3 illustrates a diagrammatic view of the essential components of one potential embodiment of the personal transportation vehicle 100 of the present invention in accordance with the disclosed architecture. As shown, the vehicle 100 may be comprised of an augmented reality or virtual reality system 301 which displays an augmented reality view of the surroundings of the vehicle 100 that is taken via at least one camera 1040 located on the exterior of the vehicle 100. As such, the view from the camera 1040 can be viewed by a rider 20 on at least one display 210 on the interior of the vehicle 100. Further, the augmented/virtual reality system 301 may provide games that can be played by the rider 20 while they are in motion, wherein portions of the game may be projected partially or entirely onto the environment around the vehicle 100.

The vehicle 100 is also comprised of a wireless communication module 302. The module 302 provides a Wi-Fi and/or cellular connection to the vehicle 100, wherein a rider 20 can connect a smartphone/smart device to the vehicle 100 via a mobile application to control various features, operations, and mechanisms of the vehicle 100. The vehicle 100 may also be comprised of a sound system 303 that is comprised of a plurality of speakers, microphones and other components to enable various mechanisms of the vehicle 100 to be controlled by voice-based commands, such as the electrical engine 304, positioning of the wheels 114, speed of the vehicle 100, and the GPS navigation system 305. In addition, a voice command may be used to control a horn 1044 of the vehicle 100.

In a differing embodiment of the vehicle 100, the GPS system 305 can be used by a fully or semi-autonomous version of the vehicle 100 in which the vehicle 100 travels to a destination once the destination location is inputted by the rider 20 via voice command. In addition, the vehicle 100 may be comprised of at least one rechargeable battery 306 that is powered by the engine 304, wherein both the engine 304 and battery 306 may receive power from the solar panels 1022. Further, the battery 306 can be charged via a charging port 1042 present on at least one of panels 102, 104, 106, 110, 112 of the vehicle 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “device”, and “personal transportation device” are interchangeable and refer to the personal transportation vehicle 100 of the present invention.

Notwithstanding the forgoing, the personal transportation vehicle 100 of the present invention and its various components can be of any suitable size and configuration as is known in the art without affecting the overall concept of the invention, provided that it accomplishes the above stated objectives. One of ordinary skill in the art will appreciate that the size, configuration and material of the personal transportation vehicle 100 and its various components as shown in the FIGS. are for illustrative purposes only, and that many other sizes and shapes of the personal transportation vehicle 100 and its components are well within the scope of the present disclosure. Although the dimensions of the personal transportation vehicle 100 and its components are important design parameters for user convenience, the personal transportation vehicle 100 and its components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personal transportation vehicle comprising:
an enclosed body;
at least three wheels; and
at least one viewing window.

2. The personal transportation vehicle of claim 1, wherein the enclosed body is comprised of a plurality of removable panels.

3. The personal transportation vehicle of claim 2, wherein the at least three wheels are arranged in a triangular configuration.

4. The personal transportation vehicle of claim 3 further comprising a wireless communication module.

5. The personal transportation vehicle of claim 4 further comprising a rechargeable battery.

6. The personal transportation vehicle of claim 5 further comprising a GPS unit.

7. The personal transportation vehicle of claim 6 further comprising a virtual reality system.

8. The personal transportation vehicle of claim 7 further comprising an LED display board.

9. The personal transportation vehicle of claim 8 further comprising an electric engine.

10. The personal transportation vehicle of claim 9 further comprising a plurality of solar panels.

11. The personal transportation vehicle of claim 10, wherein the plurality of solar panels are in electrical communication with the rechargeable battery.

12. The personal transportation vehicle of claim 11, wherein the electric engine is in electrical communication with the rechargeable battery.

13. A personal transportation vehicle comprising:
an enclosed body comprised of a front panel, a rear panel, a pair of opposing side panels, a floor panel and a removable roof panel;
at least one storage rack;
at least one solar panel attached to the roof panel;
an electric engine;
a battery in electrical communication with each of the electric engine and the at least one solar panel;
a GPS unit; and
a virtual reality system in electrical communication with the battery.

14. The personal transportation vehicle of claim 13 further comprising a plurality of wheels.

15. The personal transportation vehicle of claim 14 further comprising a wireless communication module.

16. The personal transportation vehicle of claim 15 further comprising an LED display board.

17. The personal transportation vehicle of claim 16, wherein a window is positioned along each of the front panel, the rear panel, and the pair of opposing side panels.

18. The personal transportation vehicle of claim 17, wherein each of the opposing side panels comprises a door.

19. The personal transportation vehicle of claim 17 further comprising a sound system.

20. A personal transportation vehicle comprising:
an enclosed body comprised of a top panel, a bottom panel, a front panel, a back panel, a pair of side panels, and a front hood assembly;
a set of three wheels arranged in a triangular fashion, wherein two of the set of three wheels are positioned along an axle that is attached to the bottom panel;
a plurality of LED advertising panels;
an interior display;
an adjustable seat;
a virtual/augmented reality system;
a GPS navigation system;
a horn;
a sound system;
at least one camera;
an electric engine and a rechargeable battery that are in electrical communication with at least one solar panel;
a charging port; and
at least one storage rack.
